(19) United States
(12) Patent Application Publication
(10) Pub. No.: US 2006/0034228 A1
(43) Pub. Date: Feb. 16, 2006

(54) Method for mode switching between systems in multi-mode mobile terminal

(76) Inventors: Jae-Hoon Kim, Seoul (KR); Woo-Sic Han, Anyang-si (KR); Young-Taek Choi, Seoul (KR)

Correspondence Address: MORGAN & FINNEGAN, L.L.P., 3 World Financial Center, New York, NY, 10281-2101, US

(21) Appl. No.: 11/184,238

(22) Filed: Jul. 18, 2005

(30) Foreign Application Priority Data
Jul. 22, 2004 (KR) 2004-57321

(51) Int. Cl. H04B 7/216

(52) U.S. Cl. 370/335

(57) ABSTRACT

A multi-mode mobile terminal in an idle state switches between a CDMA system mode and a WCDMA system mode. If the intensity of a WCDMA signal is maintained below a threshold value for longer than a predetermined period in a WCDMA idle state, the acquisition of the CDMA system is attempted, and a WCDMA modem is deactivated if the acquisition of the CDMA system mode was successful. Alternatively, the acquisition of the WCDMA system is attempted at regular intervals in a CDMA idle state, and a CDMA modem is deactivated if the acquisition of the WCDMA system was successful. At least any one of the two modes can be maintained in an activated state when a mode is switched into another mode so that the duration of an interruption of service can be minimized.

### BACKGROUND OF THE INVENTION

1. Field of the Invention

The present invention relates generally to a method for mode switching between systems in a multi-mode mobile terminal in an idle state and, more particularly, to a method for mode switching between a Code Division Multiple Access system and a Wideband Code Division Multiple Access system in an idle state.

2. Description of the Related Art

A terminal usable in both a Code Division Multiple Access (CDMA) network and a Wideband Code Division Multiple Access (WCDMA) network is referred to as a multi-mode terminal. A multi-mode mobile terminal is equipped with both a Radio Frequency (RF) circuit and a modem for a CDMA system, and an RF circuit and a modem for a WCDMA system to be usable in both a CDMA network and a WCDMA network. Alternatively, it is possible to integrate an RF transmission and reception circuit for CDMA system and an RF transmission and reception circuit for WCDMA system into a single part.

Meanwhile, when a mobile communication terminal moves in an idle state, the need to switch between a CDMA system and a WCDMA system occurs depending on the state of radio waves.

For example, as shown in FIG. 1, when a dual-mode or multi-mode mobile terminal 100 usable in both a WCDMA network and a CDMA network moves, in an idle state, from the region “B” where the WCDMA network and the CDMA network overlap to the region “C” where the CDMA network exists exclusively, the pilot level (e.g., a signal reception level) of a WCDMA frequency decreases while the relative pilot level of a CDMA frequency increases. At this time, the mobile terminal 100 must switch from a WCDMA system mode to a CDMA system mode. Meanwhile, in order to switch to the CDMA system mode, a process of activating a CDMA modem and performing CDMA system acquisition and location registration must be carried out. The process takes a relatively long time, so that the service may be interrupted in the process of switching from the WCDMA system mode to the CDMA system mode. Such a problem also arises in the case where a mobile terminal moves, in an idle state, from an exclusive CDMA region to the region of the WCDMA network.

### SUMMARY OF THE INVENTION

Accordingly, the present invention has been made keeping in mind the above problems occurring in the prior art, and an object of the present invention is to provide a method and system capable of minimizing the duration of an interruption of service at the time of a mode switching between a CDMA system mode and a WCDMA system mode in an idle state.

In accordance with the present invention, in a multi-mode mobile terminal operable in at least two system modes, when a request for mode switching is made in an idle state, the acquisition of a target system mode is attempted. Once it is confirmed that the target mode modem is activated successfully, the current mode modem may be deactivated so that at least one of the modems is activated throughout the transition between the modes. The request for mode switching in the idle state may be made when the intensity of a WCDMA signal is maintained below a threshold level for a predetermined period in a WCDMA idle state in which a WCDMA modem is activated. Furthermore, a request to switch into a WCDMA mode may be made at regular intervals in a CDMA idle state in which a CDMA modem is activated. Once it is determined that the acquisition of the WCDMA mode is successful, the CDMA modem may be deactivated.

In an embodiment of the present invention, the acquisition of the CDMA system is attempted if the intensity of a WCDMA signal is maintained below a predetermined threshold value for longer than a predetermined period in a WCDMA idle state, and the WCDMA modem is deactivated if the acquisition of the CDMA system acquisition was successful, so that at least one of the modems is operated throughout the switching of the system mode.

The process of attempting the acquisition of the CDMA system in the WCDMA idle state may be initiated by the WCDMA circuit unit that determines whether the intensity of a WCDMA signal is maintained below a threshold value for longer than a predetermined period in the WCDMA idle state. The WCDMA circuit unit then requests the acquisition of the CDMA system to a main control unit if it is determined that the intensity of the WCDMA signal is maintained below the threshold value for longer than the predetermined period. The main control unit, having received the request for acquisition of the CDMA system from the WCDMA circuit unit, transfers a CDMA modem activation command to the CDMA circuit unit, and the CDMA circuit unit activates the CDMA modem.

Meanwhile, it is preferred that the deactivation of the WCDMA modem is performed when both a system acquisition and a location registration are confirmed to be successful in the CDMA system. Furthermore, the CDMA circuit unit may notify the main control unit of successful system acquisition and location registration if the processes were successful in the CDMA circuit unit. The main control unit, upon receiving the notification of the successful system acquisition and location registration, transfers the WCDMA modem deactivation command to the WCDMA circuit unit. Upon receiving the command, the WCDMA circuit unit deactivates the WCDMA modem.

Meanwhile, when the acquisition of the CDMA system mode has been attempted because the intensity of the WCDMA signal is maintained below a threshold value for longer than a predetermined period but the acquisition of the CDMA system mode in the WCDMA idle state is not successful, the CDMA modem may be deactivated. That is, if the acquisition of the CDMA system mode or location registration process is failed, it is preferred that the CDMA circuit unit notifies the main control unit of the failed system acquisition or failed location registration. The main control unit, upon receiving the notification of the failed process, transfers a deactivation command to the CDMA circuit unit. In response, the CDMA circuit unit may deactivate the CDMA modem.

In another embodiment of the present invention, the acquisition of the WCDMA system mode is attempted in a CDMA idle state at regular intervals. In this embodiment, the CDMA modem is deactivated only if the acquisition of the WCDMA system was successful so that at least one of the modems is operated during the mode switching between the systems.

The process of attempting the acquisition of the WCDMA system mode in a CDMA idle state may be initiated by the CDMA circuit unit that requests the acquisition of the WCDMA system mode to the main control unit. The main control unit, upon receiving the request from the CDMA circuit unit, transfers a WCDMA modem activation command to the WCDMA circuit unit. The WCDMA circuit unit, having received the activation command from the main control unit, activates the WCDMA modem to accomplish the acquisition of the WCDMA system mode.

Meanwhile, it is preferred that the deactivation of the CDMA modem is preformed only when both of the system acquisition and location registration were successful in the WCDMA system. This process may be performed in such a way that the WCDMA circuit unit notifies the main control unit of successful system acquisition and location registration if these processes were successful. The main control unit, upon receiving the notification of the successful processes from the WCDMA circuit unit, transfers a CDMA modem deactivation command to the CDMA circuit unit, and, in response, the CDMA circuit unit deactivates the CDMA modem.

Meanwhile, when the acquisition of the WCDMA system mode was attempted in a CDMA idle state but failed, it is preferable to deactivate the WCDMA modem. That is, in an embodiment, the WCDMA circuit unit notifies the main control unit of the failed system acquisition or failed location registration if either one of these processes is failed. The main control unit, upon receiving the notification form the WCDMA circuit unit, transfers a WCDMA modem deactivation command to the WCDMA circuit unit, and, in response, the WCDMA circuit unit deactivates the WCDMA modem.

In an embodiment, the deactivation of the modem may be achieved by putting the modem in a deep sleep state.

Other and further aspect of the present invention will become apparent during the course of the following detailed description and by reference to the attached drawings.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the case where a multi-mode mobile terminal of the present invention moves from a WCDMA network region to a CDMA network region in an idle state;

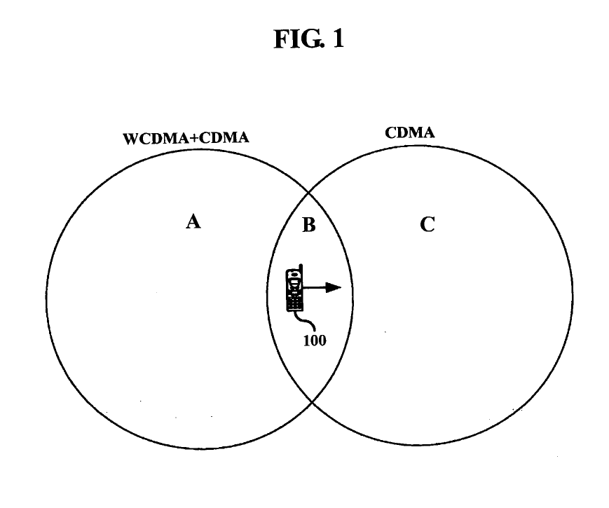

FIG. 2 is a block diagram showing the construction of the parts of the multi-mode mobile terminal of the present invention capable of performing a multi-mode operation;

FIG. 3 is a flowchart showing the operation when switching from a WCDMA system mode to a CDMA system mode is performed in an idle state of the multi-mode mobile terminal of the present invention;

FIG. 4 is a flowchart showing the operation when switching from a WCDMA system mode to CDMA system mode fails in an idle state of the multi-mode mobile terminal of the present invention;

FIG. 5 is a flowchart showing the operation when switching from a CDMA system mode to a WCDMA system mode is performed in an idle state of the multi-mode mobile terminal of the present invention; and

FIG. 6 is a flowchart showing the operation when switching from a CDMA system mode to a WCDMA system mode fails in an idle state of the multi-mode mobile terminal of the present invention.

### DETAILED DESCRIPTION OF THE INVENTION

Reference now should be made to the drawings, in which the same reference numerals are used throughout the different drawings to designate the same or similar components.

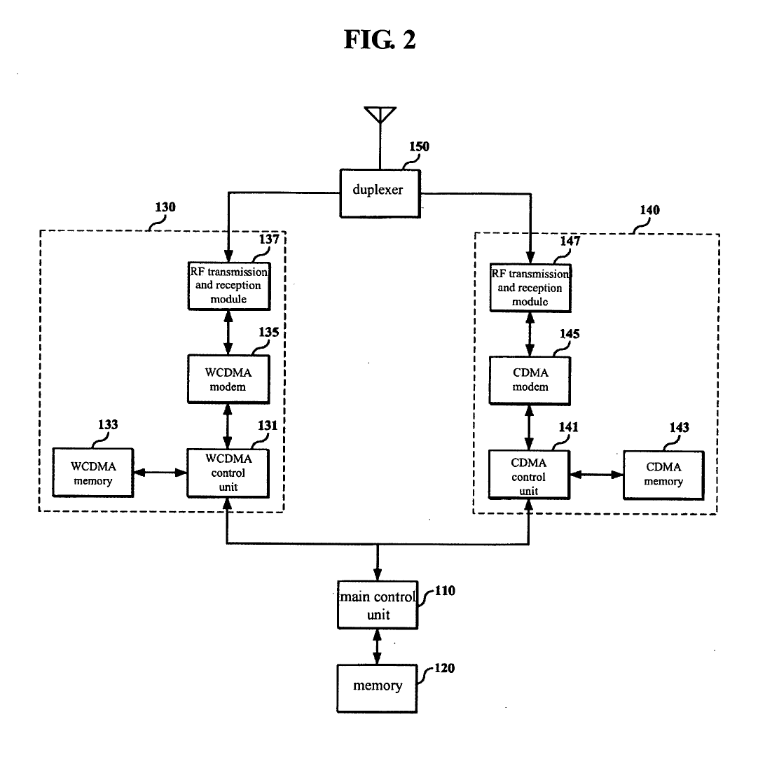

FIG. 2 is a schematic block diagram showing the configuration of the parts of a multi-mode mobile terminal, which are related to the switching of a mode between a WCDMA system and a CDMA system. The multi-mode mobile terminal capable of operating in two or more system modes is equipped with circuits for respective modes.

The present invention targets a mobile terminal that is capable of operating at least in a WCDMA system mode and a CDMA system mode. Accordingly, the multi-mode mobile terminal 100 of the present invention includes a WCDMA circuit unit 130 and a CDMA circuit unit 140. The multi-mode mobile terminal 100 further includes a main control unit 110 for controlling the operation in the two system modes and memory 120 for storing program code and data necessary for the main control unit 110. The two circuit units 130 and 140 are connected to an antenna via a duplexer 150. The duplexer 150 functions to separate a transmitted signal and a received signal from each other.

The two circuit units 130 and 140 each includes an RF transmission and reception module 137 or 147 for transmitting and receiving RF signals, a modem 135 or 145 for modulating or demodulating signals in a corresponding system mode, a control unit 131 or 141 for controlling a corresponding system mode, and memory 133 or 143 for storing programs and data necessary for operation in a corresponding system mode. These elements may be implemented separately using a plurality of Integrated Circuit (IC) chips or Monolithic Microwave ICs (MMICs), or may be implemented together using a single chip or a plurality of chips.

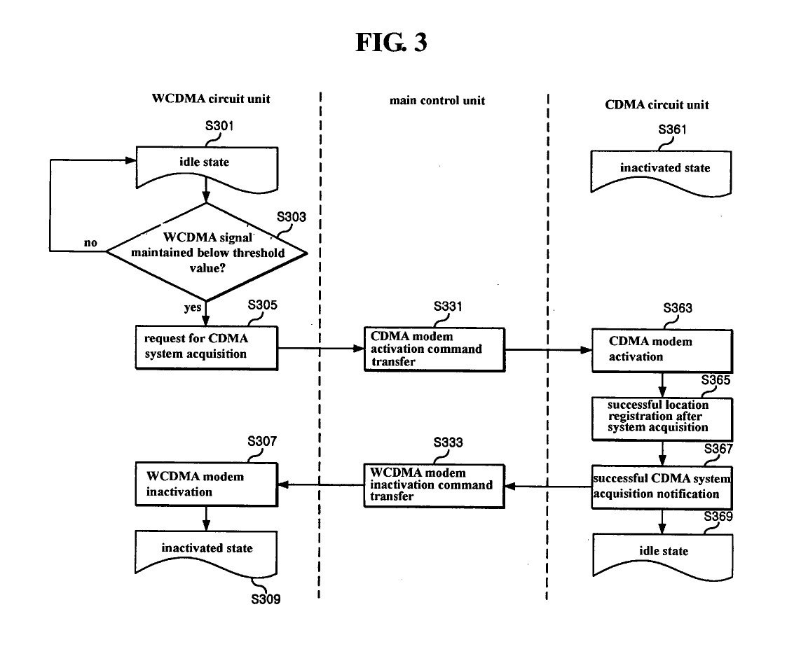

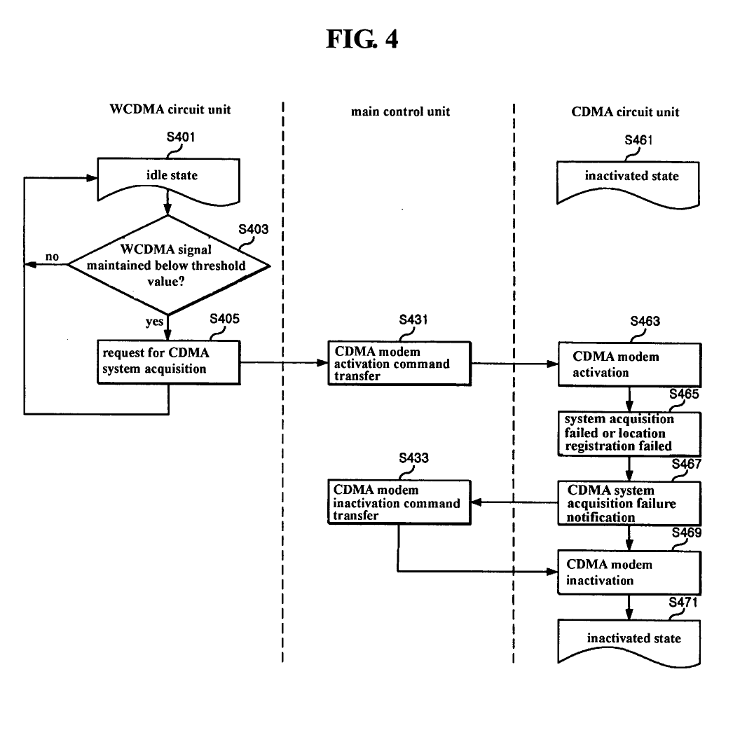

Next, with reference to FIGS. 3 and 4, a process of switching between systems when in an idle state in accordance with a first embodiment of the present invention is described in detail. FIGS. 3 and 4 are flowcharts showing the operation when the multi-mode mobile terminal moves out of a WCDMA network region in an idle state.

When power is applied to the multi-mode mobile terminal, the mobile terminal goes through an initialization process and then enters into an idle state or a stand-by state. At this time, the multi-mode mobile terminal may be operated in one of a WCDMA system mode or CDMA system mode depending on the conditions at the location of the mobile terminal. In other words, when power is applied to the mobile terminal, the main control unit 110 initializes both the WCDMA modem and the CDMA modem. When the mobile terminal connects to the WCDMA network during the initialization, the main control unit 110 puts the WCDMA modem 135 in an activated state and puts the CDMA modem 145 in a deactivated state. In contrast, when the mobile terminal does not connect to the WCDMA network during the initialization, the main control unit 110 puts the WCDMA modem 135 in a deactivated state and puts the CDMA modem 145 in an activated state.

The multi-mode mobile terminal 100 operating in a WCDMA system mode monitors the level of a WCDMA signal so as to determine whether the mobile terminal 100 in an idle state has moved out of the WCDMA network region, at step S301. Meanwhile, at this time, the CDMA circuit unit 140 is maintained in a deactivated state at step S361. If the level of a WCDMA signal is maintained below a threshold value for longer than a predetermined period (i.e., “YES” at step S303), it signifies that the mobile terminal 100 moves out of the WCDMA network region and, therefore, the WCDMA circuit unit 130 requests the acquisition of the CDMA system mode to the main control unit 110 at step S305.

Then, the main control unit 110 transfers a CDMA modem activation command to the CDMA circuit unit 140 at step S331, and the CDMA circuit unit 140, having received the activation command, activates the CDMA modem 145 at step S363. When the CDMA modem 145 is activated, the CDMA circuit unit 140 performs system acquisition and location registration. If the system acquisition and the location registration were successful at step S365, the CDMA circuit unit 140 notifies the main control unit 110 that the acquisition of the CDMA system was successful at step S367. Meanwhile, if the acquisition of the CDMA system was successful, the CDMA circuit unit 140 is put thereafter in the idle state at step S369.

The main control unit 110, having been notified by the CDMA circuit unit 140 of the successful acquisition of the system, transfers a WCDMA modem deactivation command to the WCDMA circuit unit 130 at step S333. Then, the WCDMA circuit unit 130 enters into the deactivated state at step S309 by deactivating the WCDMA modem 135 at step S307.

Accordingly, in the case where the multi-mode mobile terminal 100 moves out of the WCDMA network region in the idle state and enters into the CDMA network region while operating in the WCDMA mode, at least any one of the modes is maintained in the activated state, so that concern over an interruption of service due to the switching of a system mode is minimized.

Meanwhile, the operation in a case where the intensity of radio waves of the WCDMA network is relatively weak during operation in the WCDMA mode but the mobile terminal does not actually enter into the CDMA network region is described with reference to FIG. 4.

In that case, steps S401 to S463 of FIG. 4 are the same as steps S301 to S363 of FIG. 3, respectively, so that detailed descriptions thereof are omitted.

When the CDMA modem 145 is activated at S463, the CDMA circuit unit 140 performs system acquisition and location registration. Meanwhile, in the case where the mobile terminal does not enter into the CDMA network region, or the intensity of the radio waves of the CDMA network is not sufficient even if the mobile terminal enters into the CDMA network region, the system acquisition or location registration may be unsuccessful. When the acquisition of the CDMA system is failed at step S465, the CDMA circuit unit 140 notifies the main control unit 110 that the acquisition of the CDMA system is failed at step S467.

Then, the main control unit 110 transfers a CDMA modem deactivation command to the CDMA circuit unit 140 at step S433. The CDMA circuit unit 140, having received the command, deactivates the CDMA modem 145 at step S469 and returns to the deactivated state again at step S471. Meanwhile, after the CDMA circuit unit 140 has notified the main control unit 110 that the acquisition of the system has been failed, it is possible for the CDMA circuit unit 140 not to wait for the CDMA modem deactivation command from the main control unit 110 and to immediately deactivate the CDMA modem.

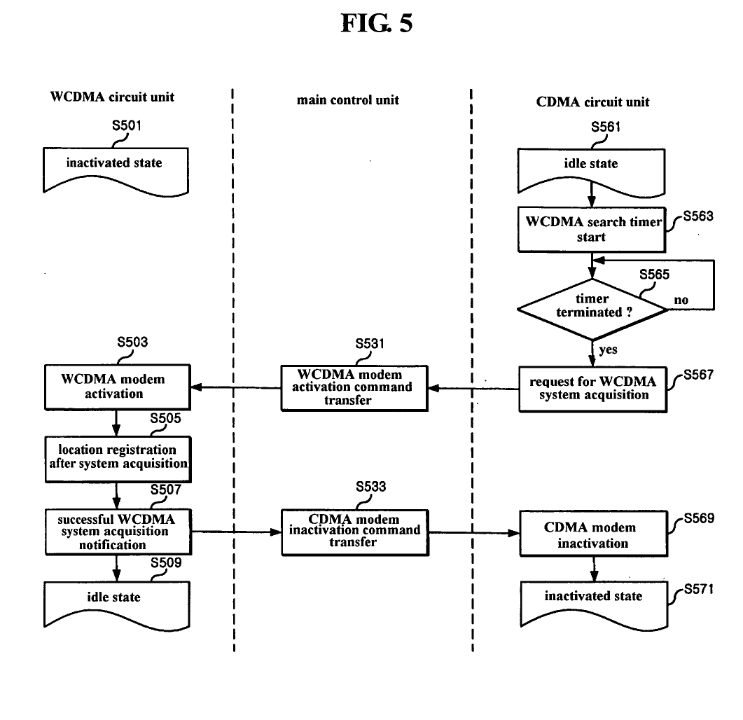

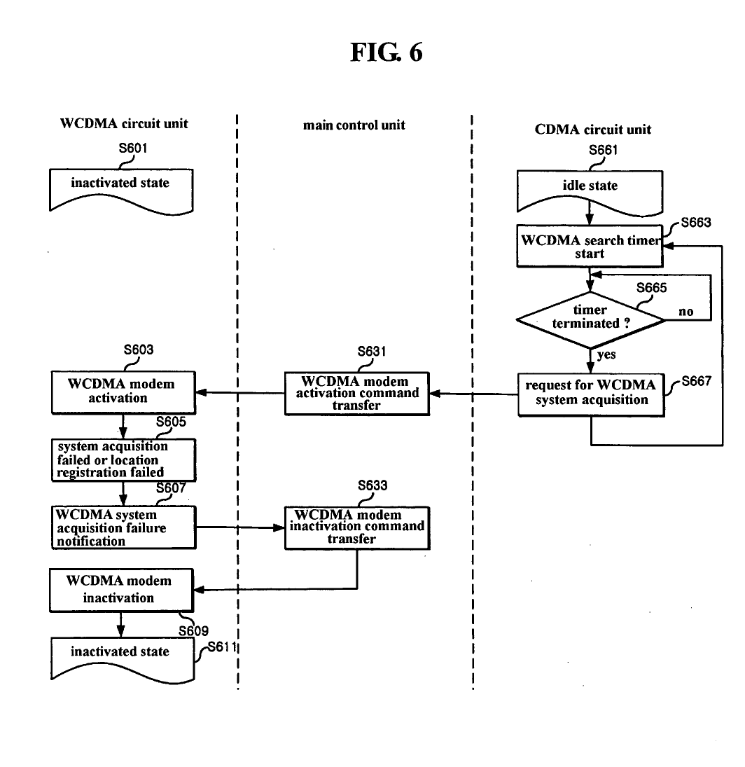

A process of switching between systems in the idle state in accordance with a second embodiment of the present invention is described with reference to FIGS. 5 and 6.

The multi-mode mobile terminal 100 operating in the CDMA system mode checks at regular intervals whether the acquisition of the WCDMA system is possible in the idle state S561, and switches to the WCDMA mode if it is determined that the acquisition of the WCDMA system is possible. Meanwhile, the WCDMA circuit unit 130 is maintained in a deactivated state S501 at that time.

For that purpose, the CDMA circuit unit 140 starts a WCDMA search timer at step S563. When the timer is terminated (i.e., “YES” at step S565), the CDMA circuit unit 140 requests the acquisition of the WCDMA system mode to the main control unit 110 at step S567. Then, the main control unit 110 transfers a WCDMA modem activation command to the WCDMA circuit unit 130 at step S531. Meanwhile, steps S563 to S567 may be skipped and step S531 is performed in the main control unit 110 at predetermined intervals.

The WCDMA circuit unit 130, having received the WCDMA modem activation command, activates the WCDMA modem 135 at step S503. When the WCDMA modem 135 is activated, the WCDMA circuit unit 130 performs system acquisition and location registration. When these processes are successful at step S505, the WCDMA circuit unit 130 notifies the main control unit 110 that the WCDMA system acquisition was successful at step S507. Meanwhile, when the system acquisition was successful, the WCDMA circuit unit 130 is subsequently put into an idle state at step S509.

The main control unit 110, having been notified by the WCDMA circuit unit 130 of the successful system acquisition, transfers a CDMA modem deactivation command to the CDMA circuit unit 140 at step S533. Then, the CDMA circuit unit 140 enters into a deactivation state at step S571 by deactivating the CDMA modem 145 at step S569.

Meanwhile, the operation in the case where WCDMA system acquisition is attempted but failed is described with reference to FIG. 6. In this case, steps S661 to S667 and steps S631 and S603 of FIG. 6 are the same as steps S561 to S567 of FIG. 5 and steps S531 and S503 of FIG. 5, respectively, so that descriptions thereof are omitted.

When the WCDMA modem 135 is activated at step S603, the WCDMA circuit unit 130 performs system acquisition and location registration. Meanwhile, in the case where the mobile terminal does not enter into the WCDMA network region, or the intensity of the radio waves of the WCDMA network is not sufficient even if the mobile terminal enters into the WCDMA network region, the system acquisition or location registration may be failed. If the WCDMA system acquisition is failed at step S605, the WCDMA circuit unit 130 notifies the main control unit 110 that the WCDMA system acquisition is failed at step S607.

Then, the main control unit 110 transfers a WCDMA modem deactivation command to the WCDMA circuit unit 130 at step S633. The WCDMA circuit unit 130, having received the command, deactivates the WCDMA modem 135 at step S609 and returns to the deactivated state again at step S611. Meanwhile, after the WCDMA circuit unit 130 has notified the main control unit 110 that the acquisition of the system is failed, the WCDMA circuit unit 130 may not wait for the WCDMA modem deactivation command from the main control unit 110 and immediately deactivate the WCDMA modem.

Examples of a method of deactivating the modem may include turning off the modem, putting the modem in a sleep state, or putting the modem in a deep sleep state. The deep sleep state refers to a state in which the power of a modem is not turned off and the RF part of the modem and most of the functions thereof are deactivated. Accordingly, a modem in a deep sleep state does not influence the operation of another modem, and power is applied to the modem. As a result, in the case where the method of putting a modem in the deep sleep state when the modem is deactivated is employed, the modem in the deactivated state can be activated without initialization when the modem in the deactivated state is activated, so that the duration of system mode switching can be reduced.

In accordance with the present invention, any one of the system modes can be maintained in the activated mode at the time of switching a system mode between the CDMA system and the WCDMA system, so that the duration of an interruption of service can be minimized.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of switching between system modes in a multi-mode mobile terminal in an idle state, comprising the steps of:
(a) making an attempt to acquire a Code Division Multiple Access (CDMA) system mode when intensity of a Wideband CDMA (WCDMA) signal is maintained below a threshold value for longer than a predetermined period in a WCDMA idle state; and
(b) deactivating a WCDMA modem when the acquisition of the CDMA system mode is successful.

2. The method as set forth in claim 1, wherein the step (a) further comprises the steps of:
(a-1) determining, by a WCDMA circuit unit, whether the intensity of the WCDMA signal is maintained below the threshold value for longer than the predetermined period in the WCDMA idle state;
(a-2) if it is determined that the intensity of the WCDMA signal is maintained below the threshold value for longer than the predetermined period, requesting the acquisition of the CDMA system mode to a main control unit by the WCDMA circuit unit;
(a-3) upon receiving the request for acquisition of the CDMA system mode from the WCDMA circuit unit, transferring a CDMA modem activation command to a CDMA circuit unit by the main control unit; and
(a-4) upon receiving the CDMA modem activation command from the main control unit, activating a CDMA modem and making an attempt to acquire the CDMA system mode by the CDMA circuit unit.

3. The method as set forth in claim 1, wherein the step (b) is performed only if the system acquisition and location registration are successful.

4. The method as set forth in claim 3, wherein the step (b) further comprises the steps of:
(b-1) if it is determined that the CDMA system acquisition and the location registration were successful, notifying the main control unit of successful CDMA system acquisition and location registration by the CDMA circuit unit;
(b-2) upon receiving the notification of the successful CDMA system acquisition and location registration, transferring a WCDMA modem deactivation command to the WCDMA circuit unit by the main control unit; and
(b-3) upon receiving the WCDMA modem deactivation command, activating the WCDMA modem by the WCDMA circuit unit.

5. The method as set forth in claim 1, further comprising the step of (c) activating a CDMA modem if the acquisition of the CDMA system mode is failed as a result of the attempt to acquire the CDMA system mode at step (a).

6. The method as set forth in claim 5, wherein the step (c) further comprises the steps of:
(c-1) if it is determined that the CDMA system acquisition or location registration is failed, notifying the main control unit of failed system acquisition or failed location registration by the CDMA circuit unit;
(c-2) upon receiving the notification of the failed CDMA system acquisition, transferring the CDMA modem deactivation command to the CDMA circuit unit by the main control unit; and
(c-3) upon receiving the CDMA modem deactivation command, deactivating the CDMA modem by the CDMA circuit unit.

7. The method as set forth in claim 1, further comprising the step of initializing the WCDMA modem and a CDMA modem when the mobile terminal is powered on, putting the WCDMA modem in an activated state and the CDMA modem in a deactivated state when the mobile terminal is connected to a WCDMA network during the initialization, and putting the WCDMA modem in a deactivated state and the CDMA modem in an activated state when the mobile terminal is not connected to the WCDMA network during the initialization.

8. The method as set forth in any one of claims 1 to 7, wherein deactivating each of the modems is performed by putting each of the modems in a deep sleep state.

9. A method of switching between system modes in a multi-mode mobile terminal in an idle state, comprising the steps of:
(a) making an attempt to acquire a Wideband CDMA (WCDMA) system mode at regular intervals in a CDMA idle state; and
(b) deactivating a CDMA modem when the acquisition of the WCDMA system mode is successful.

10. The method as set forth in claim 9, wherein the step (a) further comprises the steps of:
(a-1) requesting the WCDMA system mode acquisition to a main control unit at regular intervals by a CDMA circuit unit;
(a-2) upon receiving the request for WCDMA system mode acquisition from the CDMA circuit unit, transferring a WCDMA modem activation command to a WCDMA circuit unit by the main control unit; and
(a-3) upon receiving the WCDMA modem activation command from the main control unit, activating the WCDMA modem and making an attempt to acquire the WCDMA system mode by the WCDMA circuit unit.

11. The method as set forth in claim 9, wherein the step (b) is performed only if the system acquisition and the location registration were successful.

12. The method as set forth in claim 11, wherein the step (b) further comprises the steps of:
(b-1) notifying, by the WCDMA circuit unit, the main control unit of successful WCDMA system acquisition and location registration if the WCDMA system acquisition and the location registration were successful;
(b-2) upon receiving a notification of successful system acquisition and successful location registration, transferring a CDMA modem inactivation command to the CDMA circuit unit by the main control unit; and
(b-3) upon receiving the CDMA modem inactivation command, deactivating the CDMA modem by the CDMA circuit unit.

13. The method as set forth in claim 9, further comprising the step of (c) activating a WCDMA modem if the acquisition of the WCDMA system is failed as a result of the attempt to acquire the WCDMA system at step (a).

14. The method as set forth in claim 13, wherein the step (c) further comprises the steps of:
(c-1) notifying, by the WCDMA circuit nit, the main control unit of failed WCDMA system acquisition and failed location registration if the WCDMA system acquisition and the location registration failed;
(c-2) upon receiving a notification of failed WCDMA system acquisition, transferring a WCDMA modem inactivation command to the WCDMA circuit unit by the main control unit;
(c-3) upon receiving the WCDMA modem inactivation command, deactivating the WCDMA modem by the WCDMA circuit unit.

15. The method as set forth in claim 9, further comprising the step of initializing a WCDMA modem and the CDMA modem when the mobile terminal is powered on, putting the WCDMA modem in an activated state and the CDMA modem in a deactivated state when the mobile phone is connected to a WCDMA network during the initialization, and putting the WCDMA modem in a deactivated state and the CDMA modem in an activated state when the mobile phone is not connected to the WCDMA network during the initialization.

16. The method as set forth in any one of claims 9 to 15, wherein putting of either one of the modems in the deactivated state is performed by putting either one of the modems in a deep sleep state.

17. A method of switching between system modes in a multi-mode mobile terminal in an idle state, comprising the steps of:
(a) initializing a WCDMA modem and a CDMA modem when a mobile terminal is powered on, entering into a WCDMA system mode by putting the WCDMA modem in an activated state and the CDMA modem in a deactivated state when the mobile terminal is connected to a WCDMA network during the initialization, and entering into a CDMA mode by putting the WCDMA modem in a deactivated state and the CDMA modem in an activated state when the mobile terminal is not connected to the WCDMA network during the initialization;
(b) making an attempt to acquire a CDMA system if intensity of a WCDMA signal is maintained below a threshold value for longer than a predetermined period in an idle state of a WCDMA system mode, and deactivating the CDMA modem if the acquisition of the CDMA system was successful; and
(c) making an attempt to acquire the WCDMA system by activating the WCDMA modem in an idle state of the CDMA system mode at regular intervals and deactivating the CDMA modem if the acquisition of the WCDMA system was successful.

18. The method as set forth in claim 17, further comprising the step of deactivating the CDMA modem if the acquisition of the CDMA system is failed as a result of the attempt to acquire the CDMA system at step (b).

19. The method as set forth in claim 17, further comprising the step of deactivating the WCDMA modem if the acquisition of the WCDMA system is failed as a result of the attempt to acquire the WCDMA system at step (c).

20. The method as set forth in claim 17, wherein putting of either one of the modems in the deactivated state is performed by putting either one of the modems in a deep sleep state.

21. A method of switching between systems in a multi-mode mobile terminal in an idle state, the multi-mode mobile terminal being capable of operating in at least two modes, the method comprising the step of:
if a request for mode switching is made in the idle state, making an attempt to acquire a target mode system by putting a current mode modem into a deep sleep state and activating a target mode modem which is in a deep sleep mode.

22. The method as set forth in claim 21, wherein the request for mode switching in the idle state is made if intensity of a WCDMA signal is maintained below a threshold value for longer than a predetermined period in a WCDMA idle state in which the WCDMA modem is activated.

23. The method as set forth in claim 21, wherein the request for mode switching in the idle state is made at regular intervals in a CDMA idle state in which the CDMA modem is activated.
